(19) United States
(12) Patent Application Publication
(10) Pub. No.: US 2008/0172935 A1
(43) Pub. Date: Jul. 24, 2008

(54) Conservatory apparatus

(76) Inventor: Chiang-Kuei Feng, Kaohsiung County (TW)

Correspondence Address: Joe McKinney Muncy, PO Box 1364, Fairfax, VA, 22038-1364, US

(21) Appl. No.: 11/655,900

(22) Filed: Jan. 22, 2007

(51) Int. Cl. A01G 9/14

(52) U.S. Cl. 47/17

(57) ABSTRACT

A conservatory apparatus includes an inner trellis and an outer wall surrounding the inner trellis. The inner trellis and the outer wall are interposed by a convection space. A top trellis is provided at the top end of the outer wall. One or more shading layer is provided at the top end of an inner side of the inner trellis. A water wall is provided at one end of the inner trellis. A plurality of air ventilation equipment is provided at another end of the outer wall opposite to the water wall. A lower mask is provided in the inner trellis outside the water wall, and an upper mask is provided at one end outside the convection space above the lower mask. A temperature control device is provided in the inner trellis, and a monitor and control device is provided outside the conservatory to control the upper mask, lower mask and the like.

### FIELD OF THE INVENTION

The present invention relates to a conservatory apparatus and particularly to a conservatory apparatus to monitor, control and regulate air convection in a conservatory.

### BACKGROUND OF THE INVENTION

Conservatory or greenhouse is one of common facilities to grow living things. The growing condition of the living things in the conservatory is affected by temperature, humidity, sunshine, air convection and the like. Hence to accurately control the environmental factors in the conservatory is one of the important issues for the growers.

Refer to FIGS. 1 and 2 for a conventional conservatory 1 which includes an inner trellis 10 and an outer trellis 11. The inner trellis 10 has a water wall 12 on a front end and an air ventilation equipment 13 on a rear end. The inner trellis 10 and the outer trellis 11 further are interposed by a plurality of shading layers 14.

Referring to FIG. 3, during summer or when the weather temperature is higher, the temperature inside the conservatory 1 usually is higher than the exterior temperature about a few degrees. The growing condition of the living things in the conservatory 1 such as orchids and the like will be affected by weather variations. The shading layers 14 can reduce the intensity of sunshine and temperature in the conservatory 1. Moreover, when the temperature in the conservatory 1 is too high, the ventilation equipment 13 can draw out the air in the conservatory 1, and the air outside the conservatory 1 can pass through the water wall 12 to lower the temperature through moisture. Therefore the temperature in the conservatory 1 can be lowered to a range desirable to grow the orchids.

Referring to FIG. 4, during winter or when the weather temperature is lower, sunshine can pass through the outer trellis 11 and the inner trellis 10 to raise the temperature in the conservatory I higher than the exterior temperature about a few degrees (namely the greenhouse effect). A portion of air outside the conservatory 1 can pass through the water wall 12 which does not have water into the conservatory 1 to carry the air of a lower temperature into the conservatory 1 to gradually lower the temperature in the conservatory 1. However, the ventilation equipment 13 cannot effectively stop the outside air from entering into the conservatory 1. When the temperature outside the conservatory 1 is too low, the temperature in the conservatory 1 cannot be maintained at a temperature range suitable for growing the orchids. The growth condition of the orchids suffers, and growing quantity and quality could drop. It could result in a higher cost for the growers.

### SUMMARY OF THE INVENTION

Therefore the primary object of the present invention is to provide a conservatory apparatus to control the environment to become suitable for growing living things.

To achieve the foregoing object, the conservatory apparatus according to the invention includes an inner trellis and an outer wall which surrounds the inner trellis. The inner trellis and the outer wall are interposed by a convection space. A top trellis is provided on the top end of the outer wall. There is a water wall at one end of the inner trellis. A plurality of air ventilation equipment is located on the outer wall opposite to the water wall. The inner trellis further has a lower mask on an outer side of the water wall. There is an upper mask at one end of an outer side of the convection space above the lower mask. A temperature control device is provided in the inner trellis. A monitor and control device is located outside the conservatory to control the upper mask and lower mask and the like. Thereby the growing environment in the conservatory can be controlled to suit the living things in the conservatory. And the growing quantity and quality of the living things can be increased.

By means of the design set forth above, the following results can be achieved:

1. Effective control of the conservatory environment: Through the monitor and control device the growing environment for living things in the conservatory can be controlled in an integrated manner. Through the upper mask and lower mask air convection condition in the conservatory can be controlled. Hence the temperature and humidity in the conservatory can be controlled as desired to reach a desirable environment in the conservatory.

2. Increase growing quantity and quality of the living things: Through the upper mask, lower mask and the like the environmental condition in the conservatory can be controlled as desired. By means of the integration of the monitor and control device, the growing environment for the living things in the conservatory can be maintained at a constant condition suitable for growing. Thereby growing quantity and quality of the living things can be maintained consistently.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic side view of a conventional conservatory.

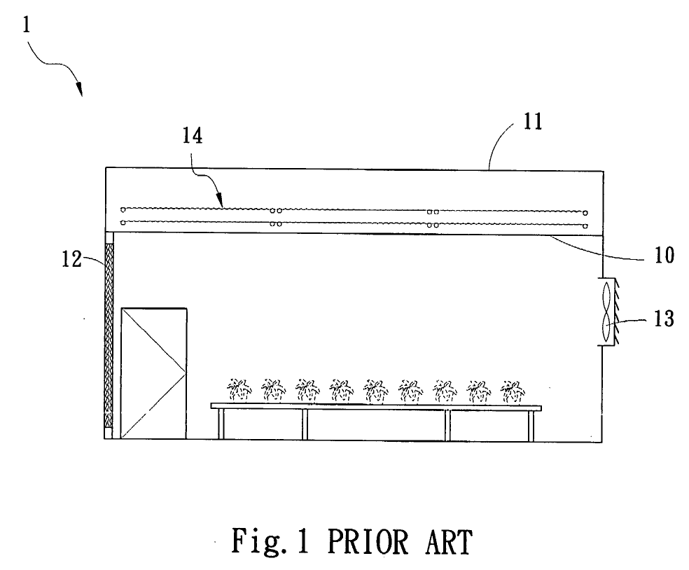

FIG. 2 is a fragmentary sectional view of a conventional conservatory.

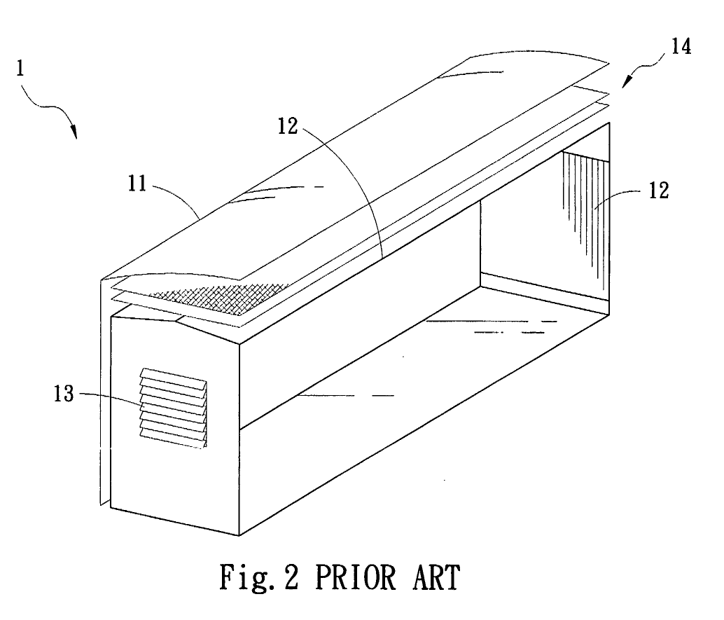

FIG. 3 is a schematic view of a conventional conservatory showing air convection in the summer.

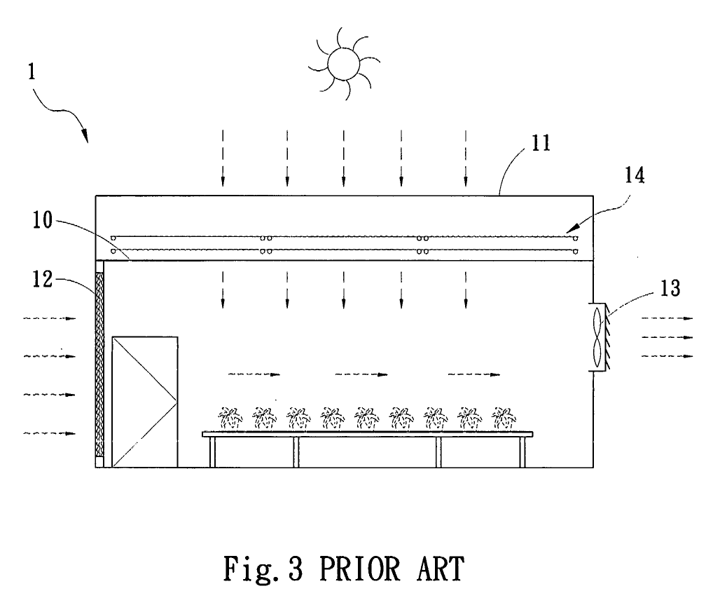

FIG. 4 is a schematic view of a conventional conservatory showing air convection in the winter.

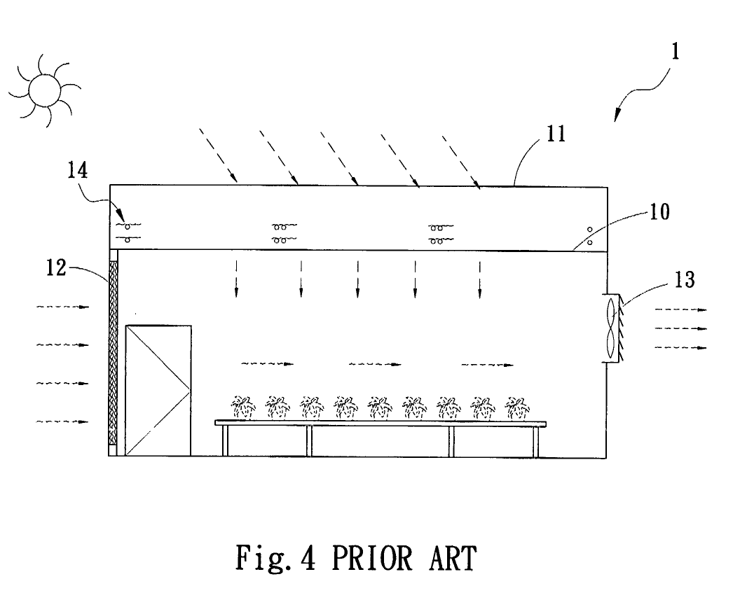

FIG. 5 is a schematic side view of the present invention.

FIG. 6 is a fragmentary sectional view of the present invention.

FIG. 7 is a schematic front view of the temperature control device of the present invention.

FIG. 8 is a schematic side view of the temperature control device of the present invention.

FIG. 9 is a schematic view of the monitor and control device of the invention.

FIG. 10 is a schematic view of the present invention showing air convection in the summer.

FIG. 11 is a schematic view of the present invention showing air convection in the winter.

### DETAILED DESCRIPTION OF THE PREFERRED EMBODIMENT

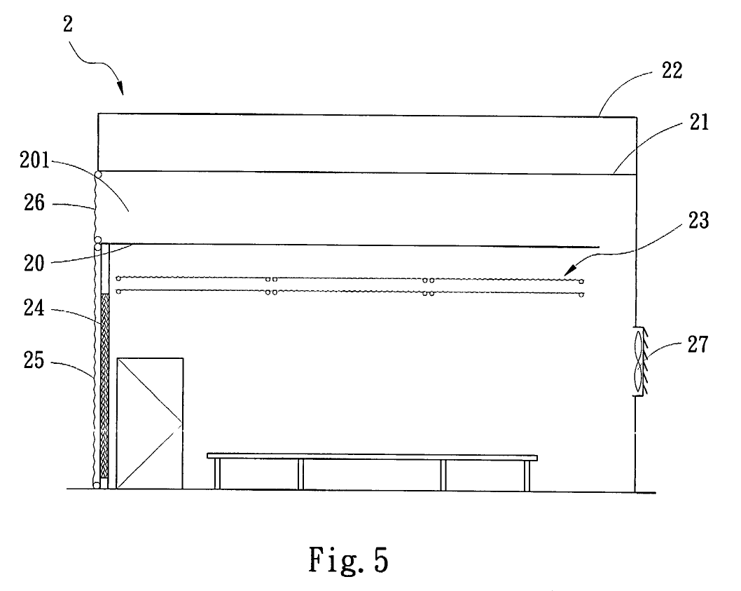

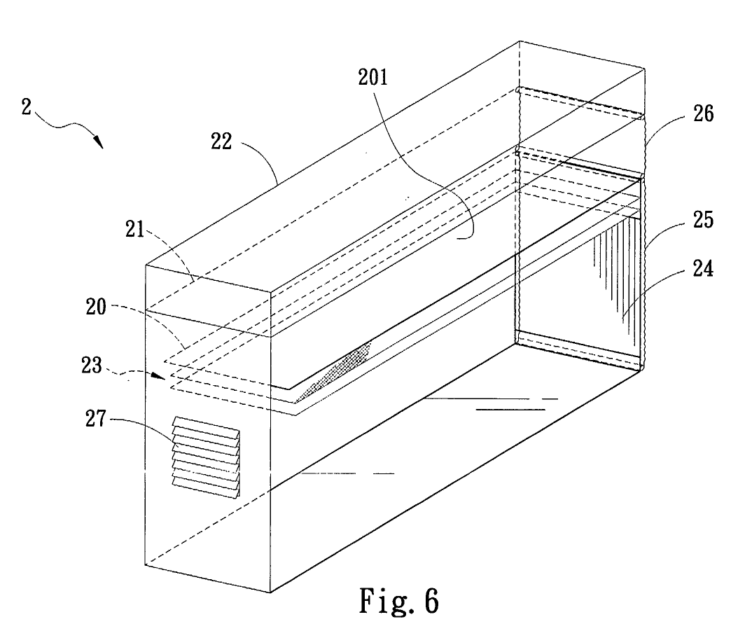

Please refer to FIGS. 5 and 6, the conservatory 2 according to the invention includes an inner trellis 20 and an outer wall 21. The outer wall 21 surrounds the inner trellis 20. The inner trellis 20 and the outer wall 21 are interposed by a convection space 201. A top trellis 22 is provided on the top end of the outer wall 21. There are one or more shading layers 23 on the top end of the inner side of the inner trellis 20 to shade sunshine.

A water wall 24 is provided at the front end of the inner trellis 20. There is a lower mask 25 located on an outer side of the water wall 24, and an upper mask 26 located above the lower mask 25 at one end outside the convection space 201. A plurality of air ventilation equipment 27 is located on another end of the outer wall 21 opposite to the water wall 24 to control air convection in the inner trellis 20. The lower mask 25 and the upper mask 26 may be rollable vertically, or extendable left and right, or the like.

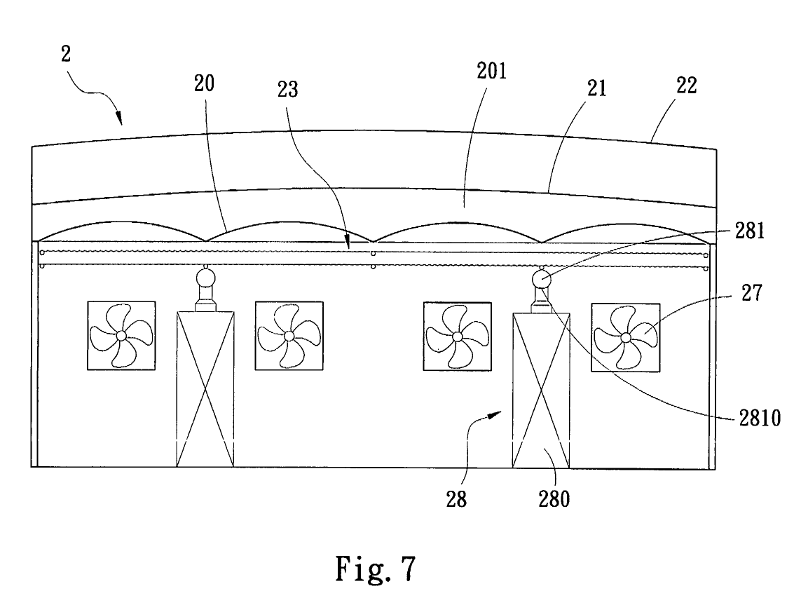

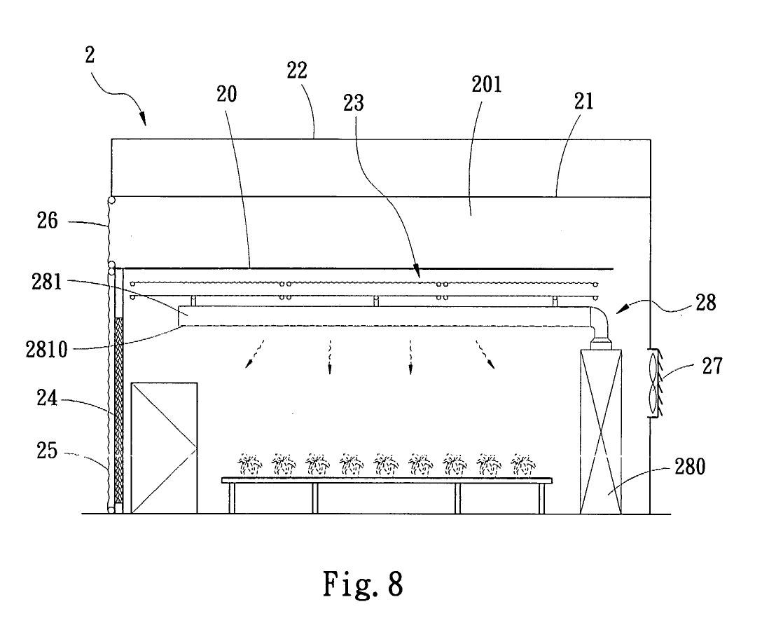

Referring to FIGS. 7 and 8, there is a plurality of temperature control devices 28 located in the inner trellis 20. The temperature control devices 28 include a temperature regulator 280 and a delivery duct 281 which has a plurality of air vents 2810. The delivery duct 281 is connected to an air outlet of the temperature regulator 280 and fastened to a lower side of the shading layer 23. Through the temperature regulator 280 the air to regulate the temperature in the conservatory 2 is delivered to pass through the air vents 2810 into the conservatory 2 to regulate the temperature inside the conservatory 2.

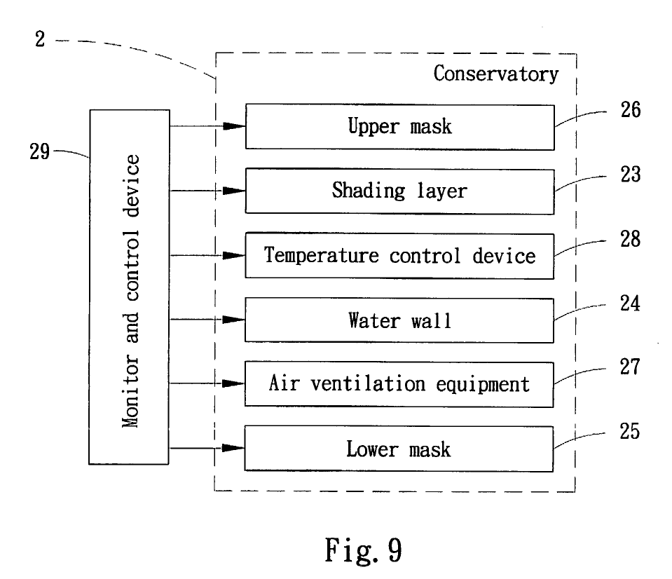

Referring to FIG. 9, the monitor and control device 29 is located outside the conservatory 2 to control operations of the shading layer 23, water wall 24, lower mask 25, upper mask 26, air ventilation equipment 27 and temperature control devices 28. Through the monitor and control device 29 the environment in the conservatory 2 can be monitored and controlled to maintain a stable growing environment for the living things in the conservatory 2. The monitor and control device 29 may also be located inside the inner trellis 20.

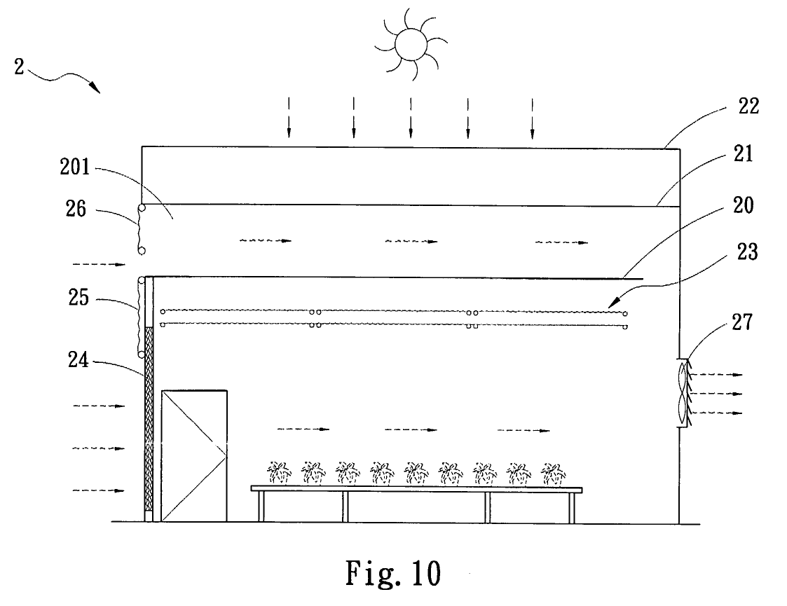

The invention takes growing orchids in the conservatory 2 as an example (referring to FIG. 10). In the summer or in a weather or location of a higher temperature, the orchids require a growing environment of a selected humidity and sunshine, the shading layer 23 at the top end of the inner trellis 20 in the conservatory 2 may be loosened and lowered to mask excessive sunshine and prevent the temperature in the conservatory 2 from rising too high.

In the event that the temperature in the inner trellis 20 is higher than the allowable range for growing the orchids, the temperature in the conservatory 2 may be regulated by means of the temperature control devices 28. Also referring to FIGS. 7 and 8, when the temperature control device 28 is activated, air to lower the temperature is delivered by the temperature regulator 280 to the delivery duct 281 which has evenly distributed air vents 2810 on a lower side to deliver the air of a lower temperature into the conservatory 2 to lower the temperature in the conservatory 2.

The water wall 24 at one end of the inner trellis 20 may also be used to lower the temperature of the external air. When the air is in contact with the moisture of a lower temperature the air temperature can be lowered so that a selected humidity can be maintained in the air. Through the air ventilation equipment 27 located at another end of the outer wall 21 opposite to the water wall 24, the air of a higher temperature in the conservatory 2 can be drawn out and replenished by the air passing through the water wall 24. Thereby the temperature in the conservatory 2 can be lowered.

Referring to FIG. 10, when the water wall 24 or temperature control device 28 is in operation, to prevent the air in the convection space 201 from affecting the temperature in the inner trellis 20, the upper mask 26 at one end of the convection space 201 may be rolled up at a height about 80%, while the lower mask 25 may be rolled up at a height about 20% so that 80% of external air passes through the water wall 24 to lower the temperature before entering the inner trellis 20, while the rest 20% of the fresh air receives sunshine and flows into the convection space 201. Thereby both the inner trellis 20 and outer wall 21 have fresh air for convection. The air temperature in the inner trellis 20 can be prevented from rising too high caused by receiving sunshine in the convection space 201. Such an approach also can save energy while the temperature control device 28 is in operation.

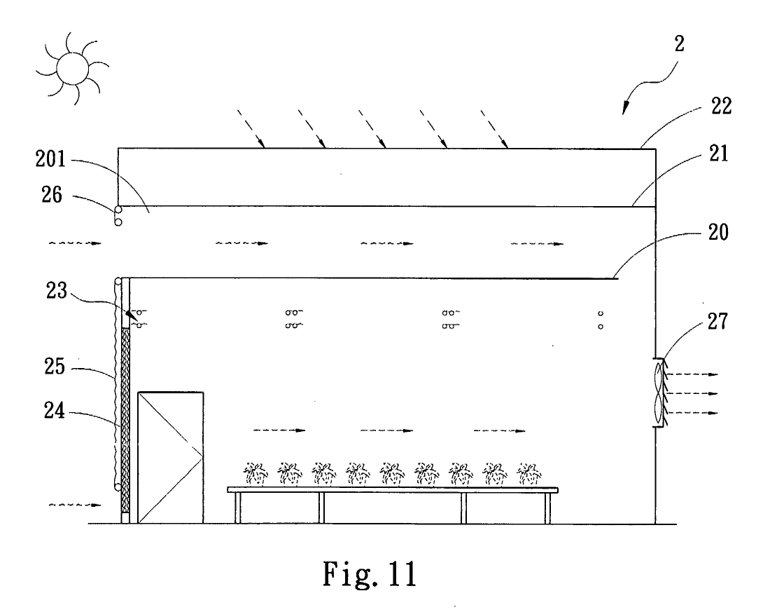

During the winter or in a weather or location of a lower temperature (referring to FIG. 11), the shading layer 23 at the top end of the inner trellis 20 can be rolled up so that sunshine can pass through the outer wall 21 and top trellis 22 to raise the temperature in the inner trellis 20 to prevent the temperature in the conservatory 2 from dropping too low.

In the event that the temperature in the inner trellis 20 is lower than the allowable range for growing the orchids, the temperature in the inner trellis 20 can be regulated through the temperature control device 28. Also referring to FIGS. 7 and 8, when the temperature control device 28 is activated, heated vapor or air is delivered through the temperature regulator 280 to the delivery duct 281, and the air vents 2810 evenly located on the lower side of the delivery duct 281 can deliver the warmer vapor or air into the conservatory 2 to raise the temperature in the conservatory 2.

Referring to FIG. 11, as the water wall 24 at one end of the inner trellis 20 and the air ventilation equipment 27 at another end of the outer wall 21 opposite to the water wall 24 cannot stop the external air of a lower temperature from entering, the lower mask 25 outside the water wall 24 can be rolled at a height about 80%, while the upper mask 26 at one end of the convection space 201 can be rolled at a height about 20%, so that the 20% of the externil air of a lower temperature can pass through the water wall 24 to maintain air convection in the inner trellis 20, while 80% of the fresh air can receive sunshine to a higher temperature and flow into the convection space 201. Moreover, the air passing through the water wall 24 and upper mask 26 can be discharged by the air ventilation equipment 27 outside the conservatory 2 so that both the inner trellis 20 and the outer wall 21 have fresh air for convection. Such an approach also prevent a great amount of lower temperature air from entering through the water wall 24 to lower the temperature in the inner trellis 20, and energy can be saved when the temperature control device 28 is in operation.

What is claimed is:

1. A conservatory apparatus, comprising at least:
a lower mask located on an outer side of a water wall of a conservatory; and
an upper mask located at one end of the conservatory above the lower mask to block a convection space formed between an inner trellis and an outer wall of the conservatory.

2. The conservatory apparatus of claim 1, wherein the upper mask is selectively a vertically rolling curtain type or an extendable and retractable left and right type

3. The conservatory apparatus of claim 1, wherein the lower mask is selectively a vertically rolling curtain type or an extendable and retractable left and right type.

4. The conservatory apparatus of claim 1, wherein extension and retraction of the upper mask or the lower mask are controlled through a monitor and control device.
